(19) United States
(12) Patent Application Publication
(10) Pub. No.: US 2021/0368777 A1
(43) Pub. Date: Dec. 2, 2021

(54) Shockem Rodent Deterrent System

(71) Applicant: Barton George Barlow, La Grande, OR (US)

(72) Inventor: Barton George Barlow, La Grande, OR (US)

(21) Appl. No.: 15/929,926

(22) Filed: May 29, 2020

(51) Int. Cl. A01M 29/24; B60R 99/00

(52) U.S. Cl. CPC A01M 29/24; B60R 2099/005; A01M 2200/00; B60R 99/00

(57) ABSTRACT

Shockem rodent deterrent system is a device that delivers a non-lethal electrical shock to rodents or other animals that contact the system. Shockem rodent deterrent system includes polyelectrical rope, polyelectrical tape or polyelectrical wire, which is attached to the upper surface of a base mat, and which is connected to an electronic charge controller. Polyelectrical rope, polyelectrical tape or polyelectrical wire, is a woven polyethylene or polyvinyl chloride coated fiberglass product with continuous strands of electrical conducting wires woven into or attached to the matrix. Base mat is a flexible, shape conforming, durable, non-electrical conductive, portable or permanent mat constructed from synthetic materials, such as polyester, polypropylene, polyvinyl chloride, or fiberglass. Alternating strips of polyelectrical rope, polyelectrical tape or polyelectrical wire, every other one designated as a positively charged electrical strip or a negatively charged electrical strip, are attached to the upper surface of the base mat using non-electrical conductive methods. Strips of positively charged polyelectrical rope, polyelectrical tape or polyelectrical wire are isolated from adjacent strips of negatively charged polyelectrical rope, polyelectrical tape or polyelectrical wire by non-electrical conductive material. Positively charged strips and negatively charged strips of polyelectrical rope, polyelectrical tape or polyelectrical wire are attached, respectively, to the positive polarity and negative polarity of an electronic charge controller. Electronic charge controller delivers a pulsing, non-lethal electrical current. Rodents or other animals that come in contact with two or more strips of polyelectrical rope, polyelectrical tape or polyelectrical wire cause the electrical circuit to be completed and a pulsing electrical shock is delivered.

### GENERAL FIELD OF THE INVENTION

Shockem rodent deterrent system is a portable or permanent system that may be used in urban or rural locations to deter rodents or other animals from entering an area, specific piece of equipment or a device. Shockem rodent deterrent system delivers a non-lethal, pulsing electrical shock to rodents that contact the system.

### BACKGROUND OF THE INVENTION

Annually, rodents cause millions of dollars in damage in the United States and internationally to, for example, recreational vehicles, on and off highway personal, utility and commercial vehicles, agricultural equipment, mobile homes, houses and shops, and food and grain storage systems. Damage occurs when rodents chew on electrical wiring, synthetic hoses and belts; live, die, and deposit feces in difficult to get to locations; contaminate food and grain storage areas, build nests in vehicle air induction systems or building air circulation systems, and in general, cost property owners, consumers and industry millions of dollars each year. (e.g., CarComplaints.com 2018; my Incredible Edible Car, 2017).

Shockem rodent deterrent system provides the following advantages over existing approaches typically used to control rodent activity and prevent damage to devices, areas or structures:
Materials used in construction has not been used by prior art, such as polyelectrical rope, polyelectrical tape or polyelectrical wire, which is attached to a shape conforming synthetic base mat.
Counters the unique biological behavior or rodents and other mammals, such as their jumping and climbing ability and adaptable learning behavior, and is effective during daylight hours or at nighttime.
Includes an adaptable system, which due to materials and techniques used in construction, and unique methods of application, may be configured to deter almost any rodent or mammal, from almost any area, environmental setting, or device.
System is easily maintained, durable and may be constructed as a permanent or portable system.
Provides a non-lethal, pulsing electrical shock to rodents or mammals, which does not harm pets or humans, does not emit annoying sounds or result in generation of hazardous vapors, liquids or waste products.

### SUMMARY OF THE INVENTION

Various designs and configurations are included here—these are not intended to limit the scope of this invention. Environmental conditions, type and biology of the rodent or mammal targeted, and the specific shape and attributes of the system being protected, for example an RV, automobile, mobile home, shop, food storage area, etc., will dictate the actual design and configuration.

Shockem rodent deterrent system includes strips of polyelectrical rope, polyelectrical tape or polyelectrical wire, which are attached to the upper surface of an electrically insulated base mat, which are connected to an electronic charge controller. Rodents that contact a minimum of two adjacent strips of polyelectrical rope, polyelectrical tape or polyelectrical wire, receive a non-lethal electrical shock, thereby deterring them from entering or inhabiting specific areas, equipment or devices. Shockem rodent deterrent system is easy to construct, is durable, works in daylight and at nighttime. Shockem rodent deterrent system can be adapted to any shape, size or configuration of an area or a device. Shockem rodent deterrent system may be installed as a permanent or temporary system. Shockem rodent deterrent system may be attached to the undercarriage or frame of, for example, a recreational vehicle, to the outside wall of a house or other structure, or placed on the surface of the ground, for example, below a vehicle or other type of equipment.

The electrically insulated base mat, to which the polyelectrical rope, polyelectrical tape or polyelectrical wire is attached, is constructed from a flexible, shape conforming and suitability durable product that can be adapted to the unique shape of an area, type of equipment or device and environmental conditions. Base mat may be constructed from materials, such as polyester, polypropylene, polyvinyl chloride, or fiberglass. Products constructed from these materials may be used, such as such as flexible, shape conforming geotextile fabric, geogrid or nylon fabric.

Polyelectrical rope, polyelectrical tape or polyelectrical wire may be attached to the upper surface of the base mat using various non-electrical conductive and durable methods, such as stitching, adhesive, heat/fusion or poly rivets. Polyelectrical rope, polyelectrical tape or polyelectrical wire is constructed from woven polyethylene or PVC coated fiberglass, and which includes continuous strands of electrical conducting wires woven into or attached to the matrix. The number of electrical conducting wires included in the polyelectrical rope, polyelectrical tape or polyelectrical wire varies depending on the specific application of the device. The width or diameter of polyelectrical rope, polyelectrical tape or polyelectrical wire and the spacing between the individual strips of polyelectrical rope, polyelectrical tape or polyelectrical wire across the upper surface of the base mat varies based on the size and biology of the rodent being deterred, and the specific equipment, device, or area where rodent deterrent is desired.

Alternating strips of polyelectrical rope, polyelectrical tape or polyelectrical wire (a minimum of two strips), are attached, using various methods, to the upper surface of the base mat. Every other strip of polyelectrical rope, polyelectrical tape or polyelectrical wire are designated as a positively charged electrical strip or a negatively charged electrical strip. Strips of polyelectrical rope, polyelectrical tape or polyelectrical wire designated as positively charged or polarity, and strips of polyelectrical rope, polyelectrical tape or polyelectrical wire designated as negatively charged or polarity are electrically isolated from each other by a separation distance, or by use of a non-electrical conducting material. The positive charged polyelectrical rope, polyelectrical tape or polyelectrical wire, and negative charged polyelectrical rope, polyelectrical tape or polyelectrical wire are connected to the positive and negative polarity of an electronic charge controller, respectively, so that a pulsing electrical shock is delivered to rodents that come in contact with two or more strips of polyelectrical rope, polyelectrical tape or polyelectrical wire.

Shockem rodent deterrent system may be placed as a temporary or permanent device, on the ground surface beneath, for example, an RV; or, it may be permanently or semi-permanently attached, using various methods, to frame members, wheel wells, tires, axles and wiring of, for example of an RV; or, it may be permanently attached to the outside or inside wall or foundation of, for example, a house or shop. Shockem rodent deterrent system may be constructed in a manner whereby it is attached to the underside of, for example an RV, and automatic or manual retractors, spools, rolls or actuators may be used to roll up or move the base mat from the front to back, or vice versa, along the underside of the RV. Further, shockem rodent deterrent system may be constructed in a manner whereby it is attached to the underside of, for example an RV, and automatic or manual retractors, spools, rolls or actuators may be used to move the base mat vertically, up or down, from the underside of the RV and lowering onto the ground surface below. In this configuration, system may be retracted when traveling down the road and may be lowered to the ground surface below when the RV is parked.

In comparison to existing approaches often used in an attempt to deter rodent activity, shockem rodent deterrent system provides a more robust, effective, reliable, and adaptable system to repel and deter rodents and mammals. Shockem rodent deterrent system is effective during daylight or nighttime, uses unique materials, such as polyelectrical rope, polyelectrical tape or polyelectrical wire attached to a non-electrical conductive base mat, and construction methods and adaptations, not previously used in similar applications to deter rodents or mammals from specific areas.

### BRIEF DESCRIPTION OF THE FIGURES

FIG. 1. a. Oblique view of polyelectrical rope, polyelectrical tape or polyelectrical wire attached to a flexible, shape conforming, non-electrical conducting base mat, and showing electrical conducting wires.

FIG. 1.b. Cross section or side view of polyelectrical rope, polyelectrical tape or polyelectrical wire polyelectrical tape, and showing electrical conducting wires woven among fibers of polyethylene or PVC coated fiberglass.

FIG. 2. Plan view or top view showing typical layout of polyelectrical rope, polyelectrical tape or polyelectrical wire attached to base mat and illustrating overlaps of positive and negative charged polyelectrical rope, polyelectrical tape or polyelectrical wire as well as connections to an electronic charge controller.

FIG. 3. Detailed cross section or side view showing one optional approach to required overlapping and electrical isolation, using non-electrical conducting materials, of positive charged and negatively charged polyelectrical rope, polyelectrical tape or polyelectrical wire, and the surface below the base mat.

FIG. 4. Detailed cross section and end view showing one embodiment whereby base mat with polyelectrical rope, polyelectrical tape or polyelectrical wire are attached to frame members or the undercarriage or architecture of, for example, a recreational vehicle.

FIG. 5. Typical layout of polyelectrical rope, polyelectrical tape or polyelectrical wire attached to the base mat and adapted to the first embodiment shown in FIG. 4. View is a top view or plan view of the layout of polyelectrical rope, polyelectrical tape or polyelectrical wire attached to base mat, which is attached to the undercarriage frame members of a recreational vehicle. Optional coverage of the recreational vehicle wheels or slide out extensions are also shown.

FIG. 6. Shows a second embodiment, and includes a detailed plan view or top view of polyelectrical rope, polyelectrical tape or polyelectrical wire attached to the base mat, which is attached to the outside wall of a house, shop or other structure.

FIG. 7. Shows a general plan view or top view of polyelectrical rope, polyelectrical tape or polyelectrical wire attached to the base mat, and connected to the outside wall at the foundation and ground surface interface of a house or other structure, using the second embodiment as detailed in FIG. 6, above.

FIG. 8. Shows a third embodiment, and a side view whereby polyelectrical rope, polyelectrical tape or polyelectrical wire is attached to the base mat, and the base mat is extended immediately below the underside or undercarriage of a recreational vehicle. Base mat is attached to mechanical retractors, which are located at the front and back the recreational vehicle. In this embodiment, retractors are used to maintain acceptable tension on the base mat, which may fluctuate depending on elongation of the base mat and the effects of environmental conditions, such as temperature and moisture content.

FIG. 9. Shows a detailed plan view or top view of a typical layout of polyelectrical rope, polyelectrical tape or polyelectrical wire attached to a base mat, which may be attached to a recreational vehicle, permanently or semi-permanently, using mechanical tension retractors (see FIG. 8), as a drop-down base mat using either longitudinal or vertical mechanical retractors (see FIGS. 10 and 11), as a fixed or non-retractable or non-drop down base mat (see FIG. 12), or as a base mat placed temporarily or permanently, onto the ground surface below a recreational vehicle (see FIG. 14).

FIG. 10. Shows a fourth embodiment, and includes a side view of retractors and a drop-down base mat with polyelectrical rope, polyelectrical tape or polyelectrical wire attached, and located along the underside of a recreational vehicle. Retractors would be permanently or semi-permanently attached to the undercarriage or frame of the recreational vehicle. Base mat would be connected to and wound up by the retractors, which may be used to lower the base mat to the surface of the ground, or near the surface of the ground, when in use. When not in use, retractors may be used to raise the base mat vertically upward into a tight position against the undercarriage of the recreational vehicle.

FIG. 11. Shows a fifth embodiment, and includes a side view of vertical actuators or spools and a drop-down base mat with polyelectrical rope, polyelectrical tape or polyelectrical wire attached, and located along the underside of a recreational vehicle. Base mat is connected to the vertical actuators or spools, which may be permanently or semi-permanently attached to the undercarriage of the recreational vehicle. Vertical actuators or spools could be mechanical and may be used to lower the base mat to the surface of the ground, or near the surface of the ground when in use. When not in use, vertical actuators or spools could be used to raise the base mat vertically upward into a tight position up against the undercarriage of the recreational vehicle.

FIG. 12. Shows a sixth embodiment, and includes a side view of polyelectrical rope, polyelectrical tape or polyelectrical wire attached to base mat whereby base mat is constructed as a non-drop down or non-longitudinally retractable design, and is located along the underside of a recreational vehicle. Rolls may be permanently or semi-permanently attached to the under carriage of the recreational vehicle at the front and back. Base mat would be wound-up in the rolls, which includes mechanical locking mechanisms. Base mat could be retained in a tight position against the undercarriage of the recreational vehicle. Rolls could also be used to allow tension adjustments of the base mat, as needed, to maintain tension or tightness of the base mat along the undercarriage of the recreational vehicle.

FIG. 13. Shows a detailed cross section or end view of a typical layout of polyelectrical rope, polyelectrical tape or polyelectrical wire attached to a base mat, which is attached to a recreational vehicle as shown and discussed in the embodiments in FIGS. 8, 10, 11 and 12.

FIG. 14. Shows a seventh embodiment, and shows a side view of placement below a recreational vehicle, temporarily or permanently, of a base mat with polyelectrical rope, polyelectrical tape or polyelectrical wire attached. Base mat may be placed onto the ground surface or slab below the recreational vehicle and held in place using a variety of non-electrical conducting methods. Also shown is the optional attachment consisting of a tire cover or overlap, or an optional ground coverage type of base mat for the area below the slide out or extension of a recreational vehicle. The optional attachment could be constructed from base mat with polyelectrical rope, polyelectrical tape or polyelectrical wire attached.

FIG. 15. Shows a detailed cross section or end view of the shockem rodent deterrent system, and a typical layout of polyelectrical rope, polyelectrical tape or polyelectrical wire attached to a base mat, which may be placed on the surface of the ground or on a slab below, for example a recreational vehicle (see FIG. 14).

### DETAILED DESCRIPTION OF THE INVENTION

Shockem rodent deterrent system includes materials, methods of construction, applications and attachments to specific devices not used by prior art. Shockem rodent deterrent system may be easily adapted to and used on, for example, recreational vehicles, on and off highway personal, utility and commercial vehicles, mobile homes, houses and shops, and food and grain storage structures. Shockem rodent deterrent system is superior to many other types of rodent control systems in that it is effective 24 hours day, may be configured to provide effective coverage for almost any device, equipment or structure, and to function properly under a wide range of environmental conditions. Further, shockem rodent deterrent system is effective against all types of rodents, is not harmful to humans, pets or wildlife, and does not produces toxic vapors or residues. The Figures listed above illustrate some of the various embodiments, and applications, of the shockem rodent deterrent system.

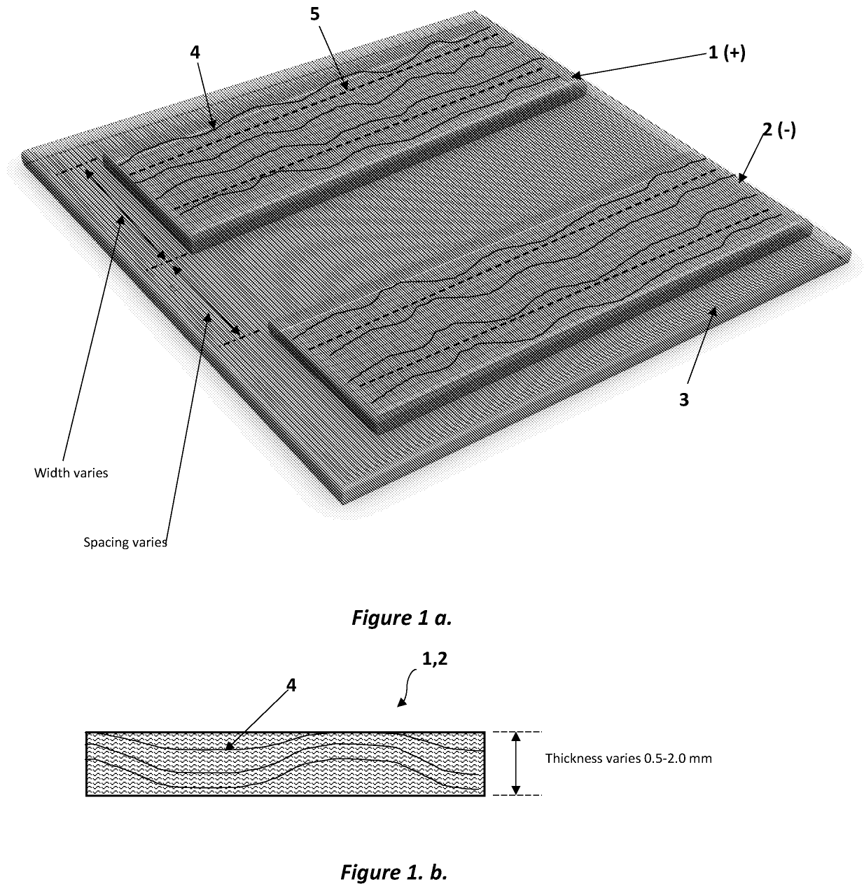

Shockem rodent deterrent system includes the following:
a minimum of one strip of polyelectrical rope, polyelectrical tape or polyelectrical wire configured to be a positively charged strip 1, and one strip of polyelectrical rope, polyelectrical tape or polyelectrical wire configured to be a negatively charged strip 2 (FIG. 1 a.),
a non-electrical conducting flexible, durable and shape conforming base mat, constructed from synthetic materials, to which polyelectrical rope, polyelectrical tape or polyelectrical wire is attached 3 (FIGS. 1 a. and b.), and
a low impedance electronic AC, DC or solar powered charge controller, to which separate leads from the positively charged and negatively charged polyelectrical rope, polyelectrical tape or polyelectrical wire are attached, and which delivers a pulsing electronic shock to rodents coming in contact with two or more strips of polyelectrical rope, polyelectrical tape or polyelectrical wire.

Polyelectrical rope, polyelectrical tape or polyelectrical wire 1, 2 is constructed from woven, braided or other durable, polyethylene or PVC coated fiberglass material (FIG. 1 a. and b.). Polyelectrical rope, polyelectrical tape or polyelectrical wire, such as Zareba® polyrope, polytape, or polywire, are shape conforming, corrosion resistant, and durable products that have interconnected electrical conducting wire strands 4 (FIG. 1, a. and b.). The number of electrical conducting wire strands per millimeter of width or diameter of polyelectrical rope, polyelectrical tape or polyelectrical wire may vary to meet the specific requirements of the application.

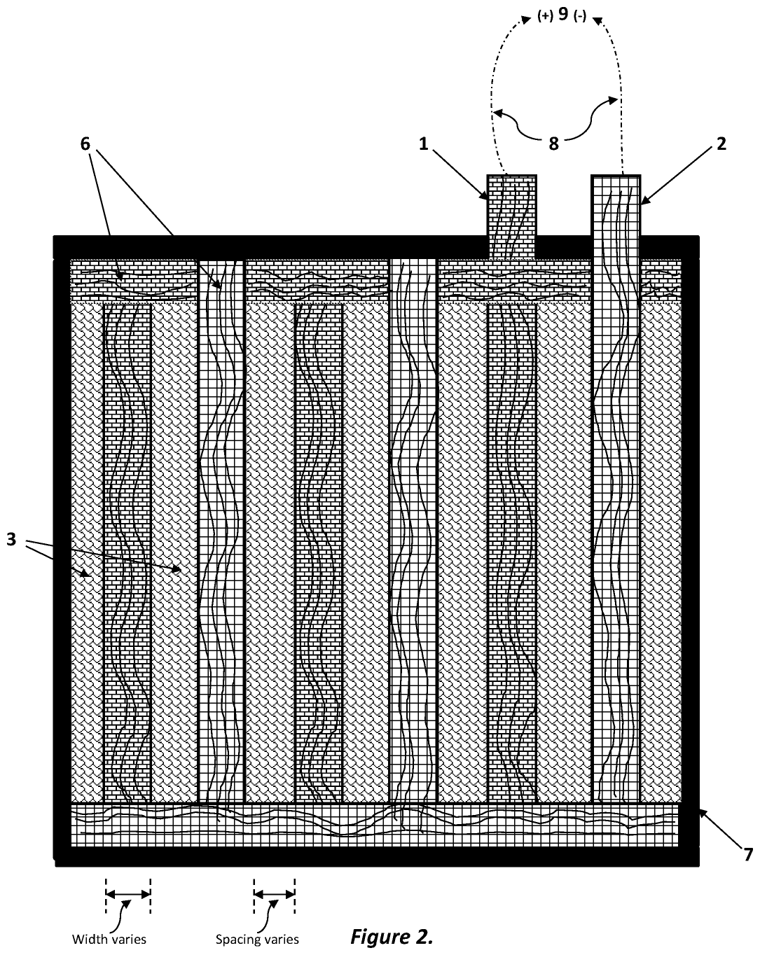

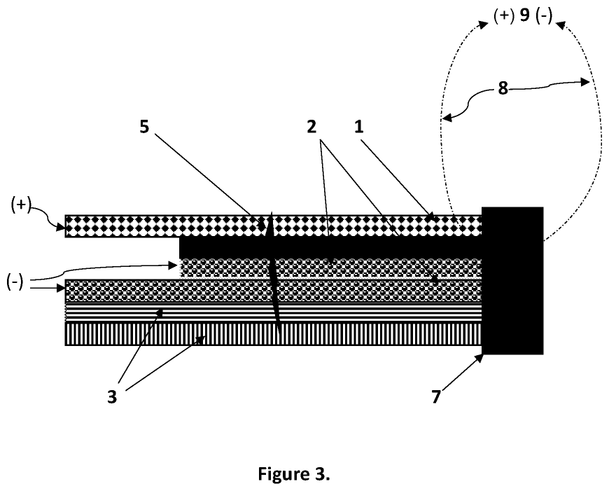

Polyelectrical rope, polyelectrical tape or polyelectrical wire 1, 2 are attached, using various methods, to a base mat 3. Base mat is constructed from synthetic materials and is durable, flexible, shape conforming and non-electrical conducting material. Examples of synthetic materials that may be used include geotextile fabrics, for example Mirafi© H P570 M, geogrid fabrics, for example Nilex® Biaxial, vinyl fabrics, for example Solera®, or a combination of these materials depending on the size and biology of the rodent targeted, specific environmental or site conditions and the embodiment. To ensure a durable apparatus, exposed edges of base mat may include an overlap of reinforced synthetic fabric, such as vinyl or PVC coated fabric 7, which is attached by non-electrical conducting stitching 5, adhesive or heat/fusion. Multiple layers of base mat 3, and various combinations of base mat, i.e., geotextile, geogrid, nylon, may be used to facilitate proper water drainage through and from below the mat (FIGS. 2 and 3), or where abrasion, and, or weight may damage the base mat, such as under recreational vehicle jacks, tires, etc., or any place or object that may cause electrical grounding.

A minimum of two strips of polyelectrical rope, polyelectrical tape or polyelectrical wire 1, 2 are attached to the upper surface of the base mat 3 by stitching 5, adhesive, poly rivets or fasteners 10, heat/fusion or other non-electrical conducting means (FIG. 1 a. and b., FIG. 2). The width or diameter of polyelectrical rope, polyelectrical tape or polyelectrical wire, and spacing between strips of polyelectrical rope, polyelectrical tape or polyelectrical wire across the base mat 3 varies by the application (see FIGS. 1 a., 2, 3 and 4). Alternating strips of polyelectrical rope, polyelectrical tape or polyelectrical wire 1, 2, every other one designated as a positively charged electrical strip or a negatively charged electrical strip, are interconnected (FIG. 2 and FIG. 3). Overlaps, junctions and contact points of polyelectrical rope, polyelectrical tape or polyelectrical wire must be shielded, and, or insulated (see FIG. 3). For example, shielding or insulating is required for contact points, such as the surface of the ground, portions of the equipment, device or structure it is intended to protect, and overlapping of adjacent or nearby strips of polyelectrical rope, polyelectrical tape or polyelectrical wire designated as positively charged and the polyelectrical rope, polyelectrical tape or polyelectrical wire designated as negatively charged. An example of required shielding or insulating techniques are shown in FIG. 3.

Strips of polyelectrical rope, polyelectrical tape or polyelectrical wire 1 designated as positively charged are interconnected and one electrical lead 8 is connected to the positive (+) charge or polarity of an electronic charge controller 9. Strips of polyelectrical rope, polyelectrical tape or polyelectrical wire designated as negatively charged 2 are interconnected and one electrical lead 8 is connected to the negative (−) charge or polarity of an electronic charge controller 9. Positive charged (+) strips of polyelectrical rope, polyelectrical tape or polyelectrical wire 1 are isolated from, and, or insulated from negative charged (−) strips of polyelectrical rope, polyelectrical tape or polyelectrical wire 2 by non-conducting materials, and from the underlying ground surface or potential electrical conducting surfaces to which the base mat is attached. Strips of polyelectrical rope, polyelectrical tape or polyelectrical wire are strategically spaced, so that a rodent stepping on two or more strips of polyelectrical rope, polyelectrical tape or polyelectrical wire will cause the electrical circuit to be completed and result in an electrical shock being delivered to the rodent. Polyelectrical rope, polyelectrical tape or polyelectrical wire are connected to an electronic charge controller, which transmits a pulsing, non-lethal electrical charge through the electrical conducting wires contained within or attached to the polyelectrical rope, polyelectrical tape or polyelectrical wire.

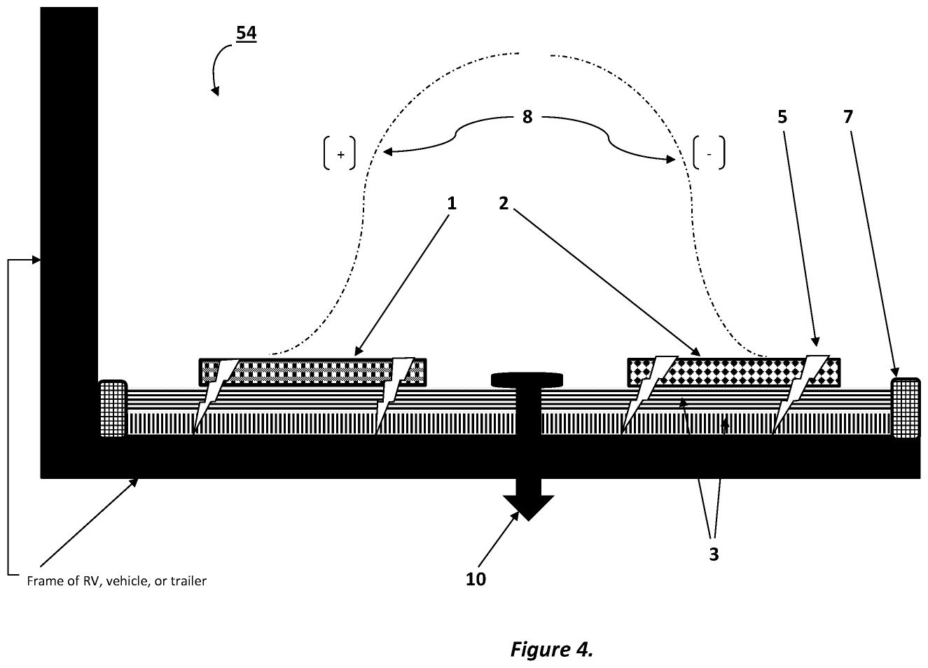

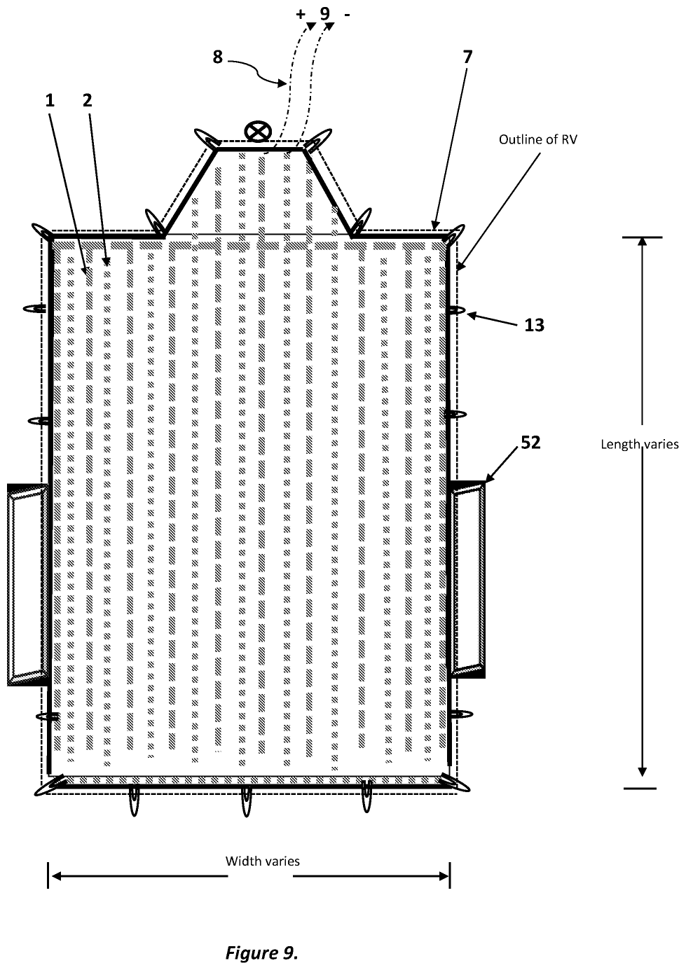

Reinforced straps or loops 13, or other durable and non-electrical conducting methods or fasteners, etc. (see FIGS. 4 and 9) may be attached to the base mat as needed to secure the system to a device or area in which it is designed to protect, and may be constructed from heavy weight vinyl, PVC coated fabric or other non-electrical conducting and durable materials, and attached by stitching 4, adhesive, poly rivets or other poly fasteners 10, or heat/fusion. Depending on the embodiment, other means of non-electrical conducting ballast may be used to retain the base mat in the proper position and under the anticipated environmental conditions.

The electronic charge controller 9 may be powered by a low impedance AC, DC or solar system. The electronic charge controller 9 provides a non-lethal, pulsing, electrical shock through the electrical conducting wires contained in the polyelectrical rope, polyelectrical tape or polyelectrical wire. The requirement for voltages that are non-lethal to humans, pets, and wildlife is fulfilled by the type of electrical charge controller 9 and power source specified, for example a Zareba® low impedance charge controller, which includes a charge limiting and duration of charge limiting circuitry.

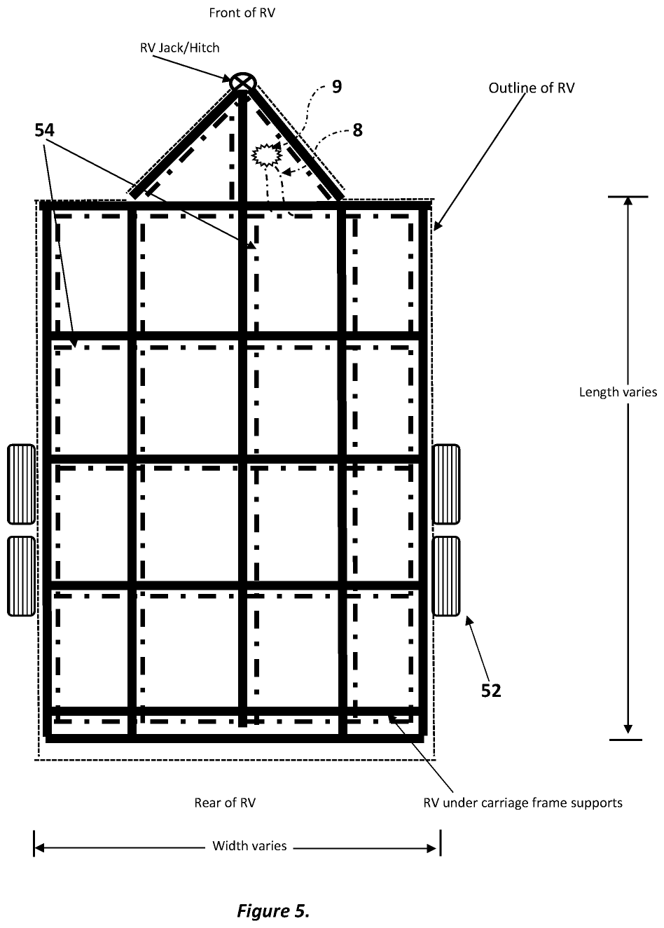

In one embodiment of this invention 54, shockem rodent deterrent system would include polyelectrical rope, polyelectrical tape or polyelectrical wire 1, 2, attached to the upper surface of a base mat 3, and base mat would be permanently or semi-permanently attached to the underside frame or architecture of, for example an recreational vehicle, mobile home, or other device as illustrated in cross section or end view in FIG. 4, and in plan view or top view in FIG. 5. Base mat 3 would be constructed from a combination of geotextile, geogrid, or nylon as needed to ensure a durable and effective apparatus. Width of base mat 3 and width and spacing of polyelectrical rope, polyelectrical tape or polyelectrical wire 1, 2 would be dependent on the specific application. Base mat 3 would be attached, using for example poly rivets or fasteners 10, or other non-electrical conducting fasteners (FIG. 4). At least two strips of polyelectrical rope, polyelectrical tape or polyelectrical wire 1, 2 would be attached to the base mat 3 (FIG. 4) by stitching 4, adhesive, heat/fusion or other non-electrical conducting and durable means. Base mat 3 and polyelectrical rope, polyelectrical tape or polyelectrical wire 1, 2 would be constructed and installed, so that no electrical grounding occurs along the frame, plumbing, axles, etc., of the device to which it is connected. Strips of polyelectrical rope, polyelectrical tape or polyelectrical wire 1 designated as positively charged would be interconnected and one electrical lead 8 would be connected the positive (+) charge or polarity of the electronic charge controller 9. Polyelectrical rope, polyelectrical tape or polyelectrical wire designated as negatively charged would be interconnected and one electrical lead 8 would be connected to the negative (−) charge or polarity of the electronic charge controller 9. Positive charged (+) strips polyelectrical rope, polyelectrical tape or polyelectrical wire would be isolated and insulated from negative charged (−) strips polyelectrical rope, polyelectrical tape or polyelectrical wire by non-conducting materials, and from electrical conducting frame members or other potential grounding sources associated with the attachment (see example in FIG. 3). A rodent coming in contact with two or more adjacent strips of polyelectrical rope, polyelectrical tape or polyelectrical wire polyelectrical tape would cause the electrical circuit to be completed, and a pulsing, non-lethal electrical shock would be delivered by the charge controller 9. This embodiment 54 has the advantages of being adaptable to many of types of equipment and devices, could be configured to be effective and be adapted to the various plumbing, wiring, axles, etc., which may protrude from the undercarriage of for example a recreational vehicle. Further, this embodiment would be durable, would not require storage or set up (once properly installed), and may be constructed for a lower or comparable cost than the other embodiments discussed here.

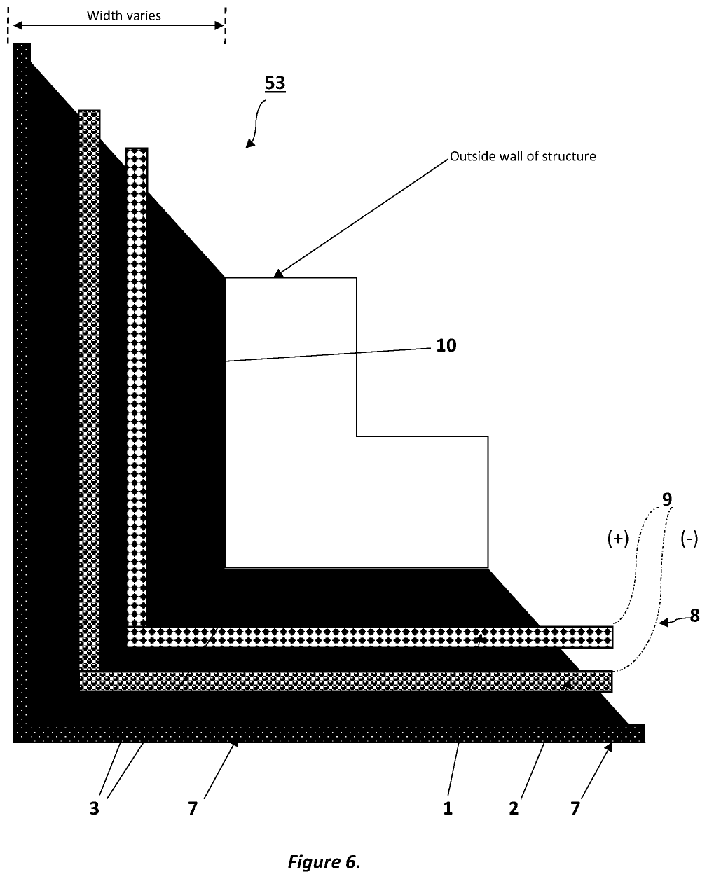

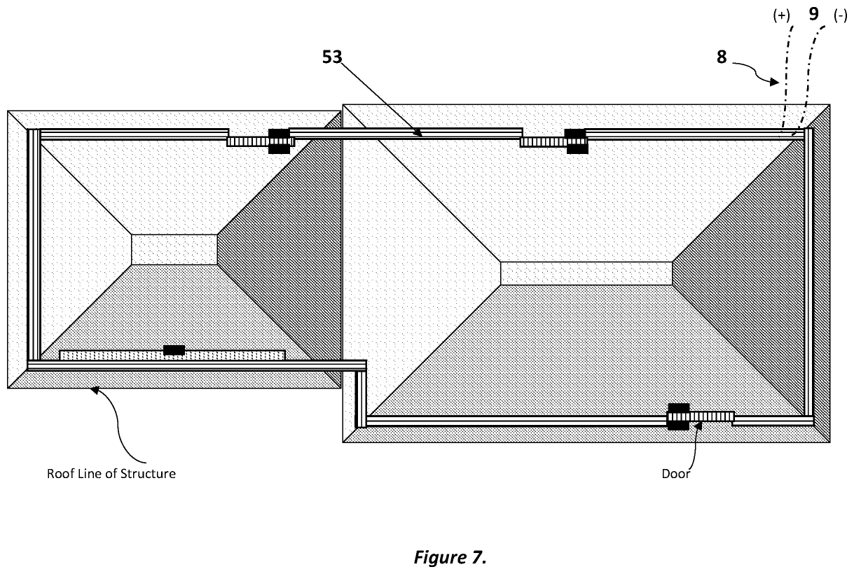

In a second embodiment of this invention 53, the shockem rodent deterrent system would include a base mat 3 with polyelectrical rope, polyelectrical tape or polyelectrical wire 1, 2 attached to the outside wall or inside wall of, for example, a house, garage, shop or other structure. This embodiment is illustrated in a detailed plan view or top view in FIG. 6, and in a general top view or plan view in FIG. 7. Width of base mat 3 and width and spacing of polyelectrical rope, polyelectrical tape or polyelectrical wire 1, 2 would be dependent on the specific application. This embodiment 53 would be constructed in a manner similar to the first embodiment discussed above 54, but would include unique adaptations as needed to allow connection to the structure it was intended to protect, and to prevent grounding from any connection points or from the ground surface. This embodiment would be durable and effective against all classes of rodents and mammals, would see widespread applicability to a variety of structures, would be easy to set up and maintain, and relatively inexpensive to construct.

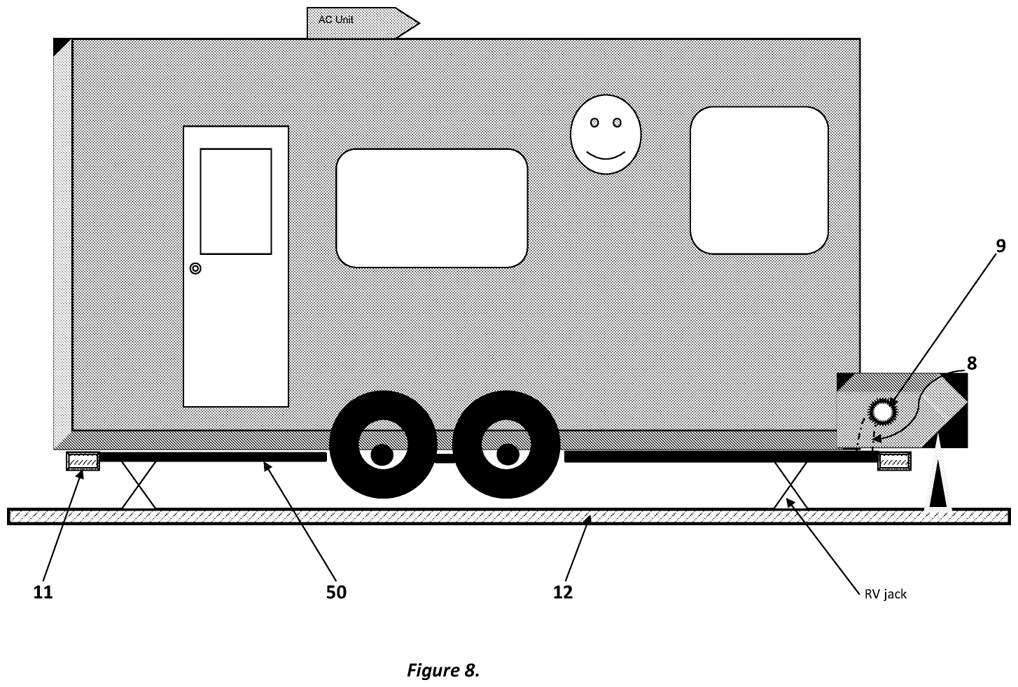

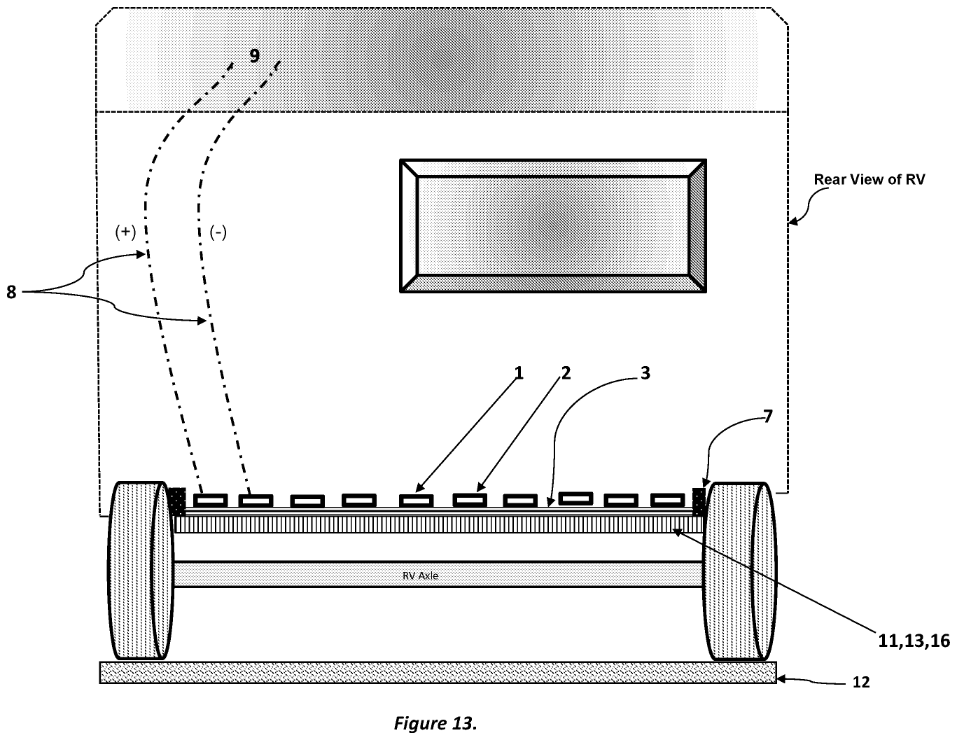

In a third embodiment of this invention 50, shockem rodent deterrent system would include a base mat 3 with polyelectrical rope, polyelectrical tape or polyelectrical wire 1, 2 attached, and mechanical retractors 11, manual or electric powered, which may be located at the front and back of, for example an recreational vehicle as shown in side view or cross section view in FIG. 8. Base mat 3 would be connected to the underside of the recreational vehicle by retractors 11, or other mechanical retracting type devices. Base mat 3 would be retractable using the retractors 11, longitudinally, front to back or vice versa, along the underside of the recreational vehicle. A typical layout of strips of polyelectrical rope, polyelectrical tape or polyelectrical wire is shown in plan view or top view in FIG. 9 and in end view or cross section in FIG. 13, using an recreational vehicle as an example. Base mat 3 would be constructed from a combination of geotextile, geogrid, and nylon as needed to ensure durability, proper retraction, and to prevent electrical grounding from the frame to which it is attached or other contact points. Base mat 3 may be constructed to provide coverage for the entire underside of the RV, or a partial base mat 3 may be used to provide protection for only a portion of the underside of the recreational vehicle. Base mat 3 would be connected to retractors 11, such as those typically used to retract or extend an awning on an recreational vehicle, and which are permanently or semi-permanently attached to the underside of the recreational vehicle. Retractors 11 would be used to retract or rollup the base mat 3 when it is not in use, for example when traveling down the road. When in a parked location, retractors would be used to extend the base mat 3 the full length or partial length of the recreational vehicle, and to retain it just below the frame or architecture of the recreational vehicle, and in a pulled-tight position (pulled up against the under carriage). This embodiment has the advantages of being effective at deterring rodents from entering, for example an recreational vehicle, would be easy to store, set up and use.

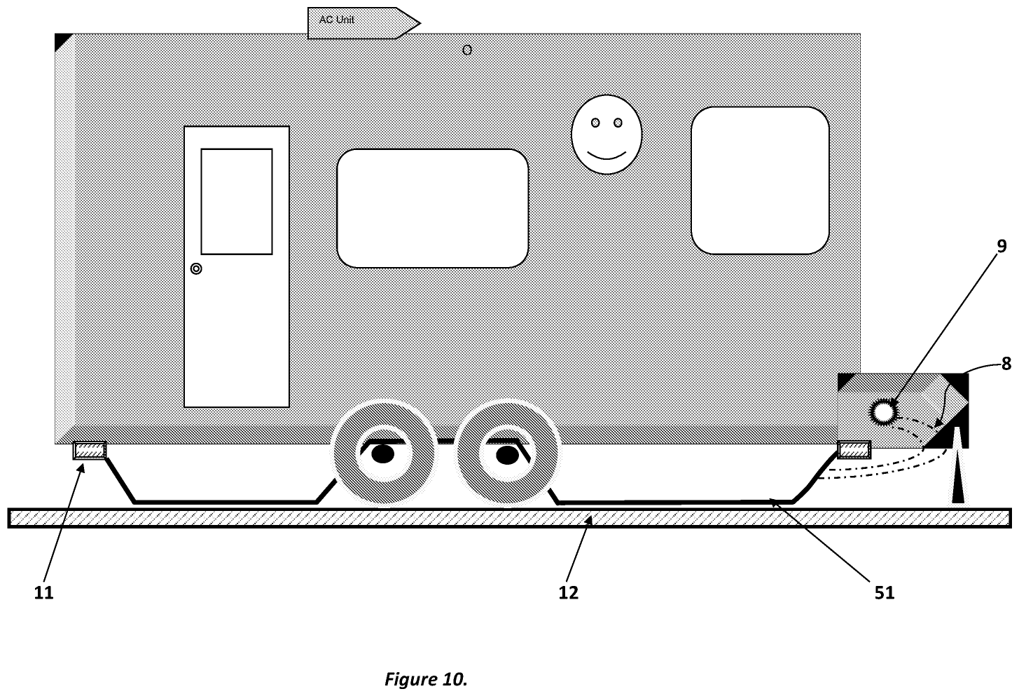

In a fourth embodiment of this invention 51 (see FIG. 10), shockem rodent deterrent system base mat 3 with polyelectrical rope, polyelectrical tape or polyelectrical wire 1, 2 attached, would be suspended front to back, in a pulled-tight mode by mechanical retractors 11 along the underside of, for example a recreational vehicle. When not in use, retractors 11 or other mechanical retracting devices, would be used to retract or pull the base mat 3 vertically upwards and tightly under the undercarriage of the RV and out of harms-way, for example when traveling down the road. When in a parked location, retractors 11 would be used to reduce the tension on the base mat 3, so it would be in a relaxed position and would drop down under the RV and drape over the axle(s) as shown in FIG. 10. Base mat 3 would be connected to retractors 11 at the back and front of the RV. Alternatively, only one retractor 11 may be used and in lieu of the second retractor 11, a permanently installed bar or fixture installed at the front or back of the RV could be substituted to retain and allow tension to be placed on the base mat 3 by the single retractor 11. This embodiment 51 is also shown in cross section and end view in FIG. 13. Base mat 3 would be constructed from a combination of geotextile, geogrid, and nylon as needed to ensure no electrical grounding occurs along the frame or other contact points, and to ensure durability. Non-electrical conducting materials would be permanently attached to the base mat where the base mat is relaxed over the axle(s) and to prevent electrical grounding (see example, FIG. 3). This embodiment 51 has the advantages of being permanently or semi-permanently attached to the device or equipment it is intended to protect, requires minimal set up time to use or put into a non-use mode, and would be easily adapted to various plumbing, wiring, axles, and architecture, which may protrude from the undercarriage of the RV, vehicle, trailer, device or other equipment.

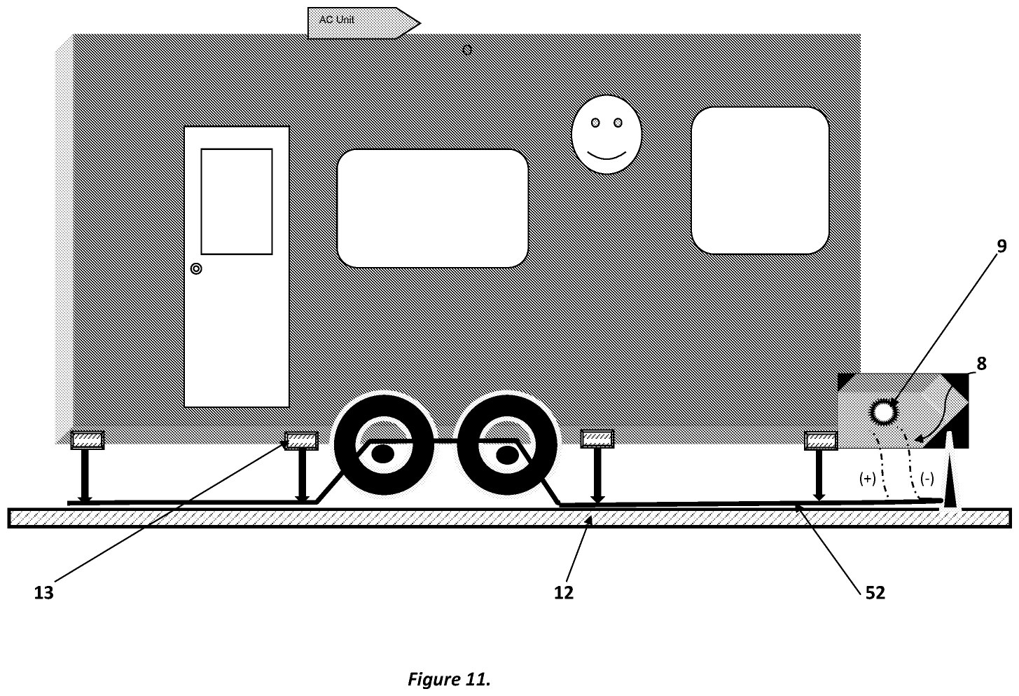

In a fifth embodiment of this invention 52, shockem rodent deterrent system base mat 3 with polyelectrical rope, polyelectrical tape or polyelectrical wire attached 1, 2, would be permanently or temporarily attached along the underside of, for example an recreational vehicle (see FIG. 11). Base mat 3 would be connected along the underside of the recreational vehicle by multiple vertical actuators or spools 13, or other mechanical retracting devices, which may be electronic or manual. Vertical actuators or spools 13 would be permanently or semi-permanently attached to and placed strategically along the under carriage of the recreational vehicle (FIG. 11). An example of the layout of polyelectrical rope, polyelectrical tape or polyelectrical wire 1, 2 on the surface of the base mat 3 is shown in top view or plan view in FIG. 9 and in cross section or end view in FIG. 13. Actuators or spools 13 to which base mat 3 would be attached would be used to move the base mat 3 vertically upward and into a pulled-tight mode against the undercarriage or architecture or the RV and out of harms-way when not in use, for example when traveling down the road. When in a parked location, actuators or spools 13 would be used to allow the tension on the base mat 3 to be relaxed and the base mat 3 would drop down vertically under the RV and drape over the axle(s) as shown in FIG. 11. Base mat 3 would be constructed from a combination of geotextile, geogrid, and nylon as needed to ensure no electrical grounding occurs along the frame or other contact points, and to ensure durability. Non-electrical conducting materials would be permanently attached to the base mat 3 where the base mat 3 is relaxed over the axle(s) and to prevent electrical grounding (see example in FIG. 3). This embodiment 52 has the advantages of being permanently or semi-permanently attached to the device or equipment it is intended to protect, requires minimal set up time to use or put in a non-use mode, and would be easily adapted to various plumbing, wiring, axles, and architecture, which may protrude from the undercarriage of the RV, vehicle, trailer, device or other equipment.

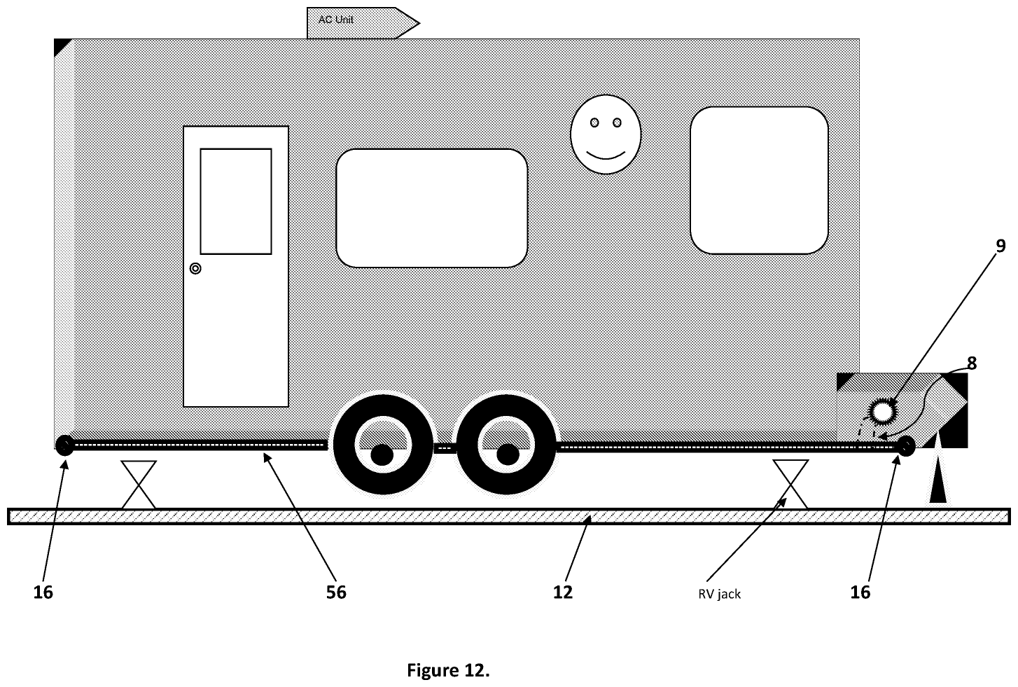

In a sixth embodiment of this invention 56, shockem rodent deterrent system, as illustrated in cross section or side view in FIG. 12, base mat 3 with polyelectrical rope, polyelectrical tape or polyelectrical wire 1, 2 attached, would be suspended along the underside of, for example an recreational vehicle, and retained permanently or semi-permanently in a pulled-tight mode by adjustable rolls 16, which are permanently or semi-permanently attached to the undercarriage or frame of the recreational vehicle. Base mat 3 would be permanently or semi-permanently attached to mechanically adjustable rolls 16 located at the front and back of the recreational vehicle, which are used to adjust tension of the base mat 3 along the underside of the recreational vehicle, as needed. Adjustment of tension of the base mat 3 using adjustable rolls 16 may be needed due to natural stretching or elongation of the base mat 3, or due to the effects of variations in environmental variables, such as temperature and moisture, on the base mat 3. Base mat 3 would also be attached to a minimum of locations along the undercarriage of the recreational vehicle by strategically placed and adjustable non-electrical conducting spacers and poly fasteners, or similar non-electrical conducting and durable means or fasteners. Base mat 3 would be constructed from a combination of geotextile, geogrid, or nylon and installed using methods and equipment as needed to ensure electrical grounding does not occur along the frame or other contact points, and to ensure durability. When the RV is parked and set up for use, the polyelectrical rope, polyelectrical tape or polyelectrical wire may be activated or electrified by turning on the electrical charge controller. When the RV was in motion, electrical charge controller would be turned off. This embodiment 56 has the advantages of no storage or set up requirements, could be constructed for a lower cost than the retractable or drop-down base mat options, and would be easily adapted to various plumbing, wiring, axles, and architecture, which may protrude from the undercarriage of an RV or other device or equipment.

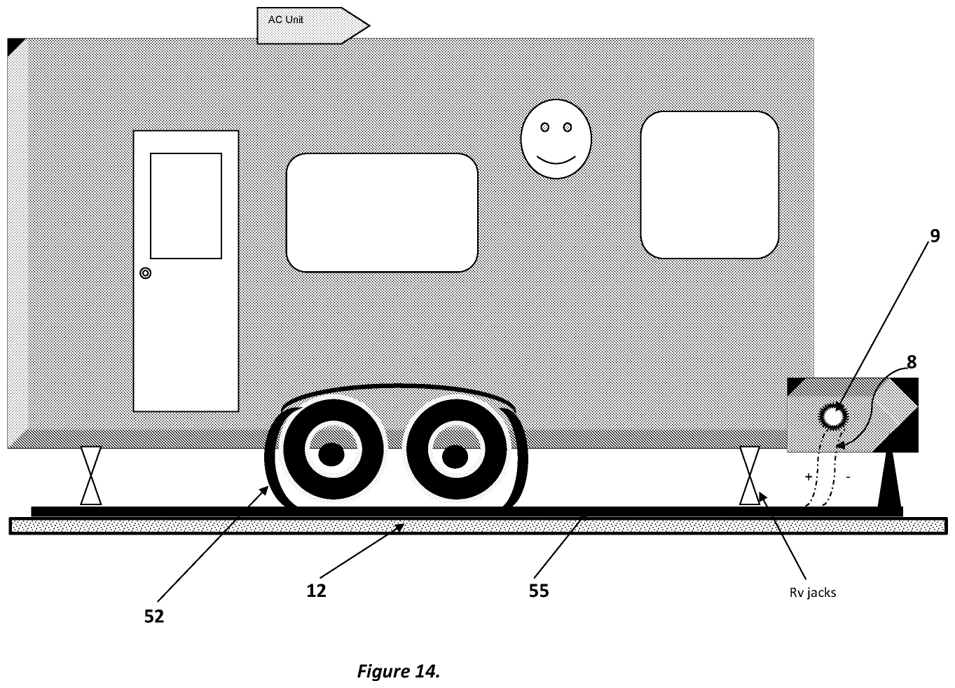

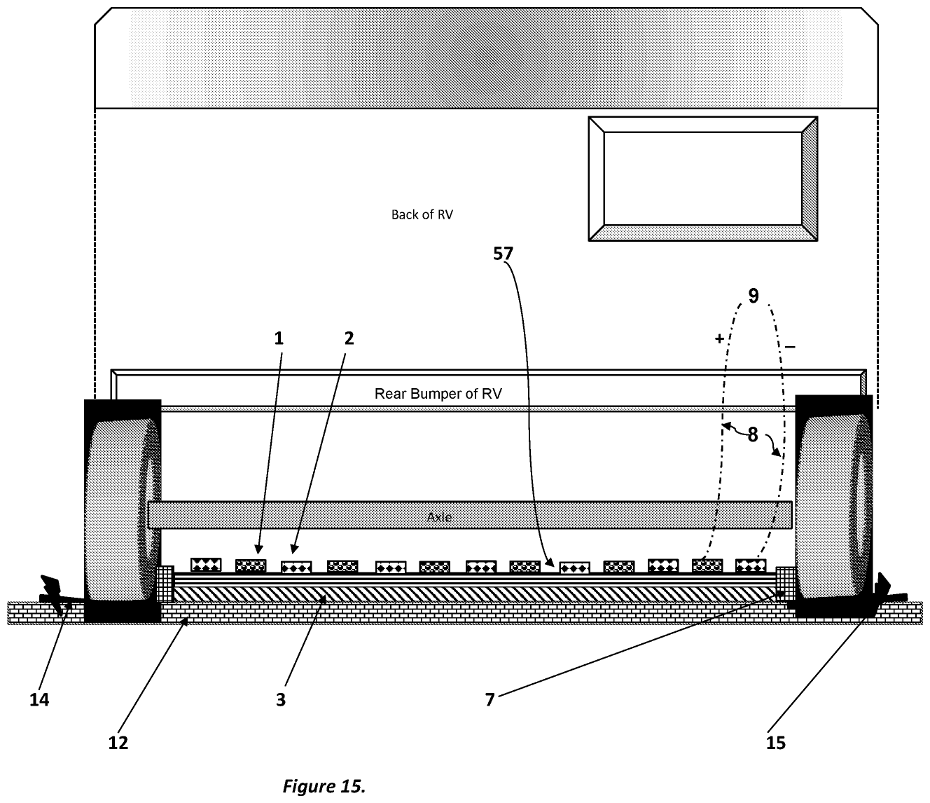

In a seventh embodiment of this invention 55, as illustrated in side view or cross section view in FIG. 14, base mat 3 is placed under, for example an RV, temporarily or permanently, and directly on the surface of the ground 12. In this embodiment 55, and if poor surface water drainage or wet soil conditions may occur, base mat 3 may include multiple layers of geotextile fabric and geogrid fabric, or other non-electrical conducting methods or materials to allow drainage of water, to ensure no grounding of polyelectrical rope, polyelectrical tape or polyelectrical wire 1, 2 would occur. A typical layout of polyelectrical rope, polyelectrical tape or polyelectrical wire and base mat 3 is shown in end view or cross section in FIG. 15. Base mat 3 may be constructed to fit almost any size of area, configuration or device, and including uneven or flat surfaces, variable composite surfaces, such as soil, rock, asphalt, etc. The ground surface below, for example the RV, is where rodents or small mammals are most likely to begin their initial reconnaissance of the area—safe places to hide, hang out or build nests, and to locate possible sources of food and water. Placement of the base mat 3 below, for example an RV, reduces the likelihood that rodents will jump up into the RV undercarriage and cause damage. The base mat 3 may be staked to the ground surface 15, held in place by the tires of the RV 14, attached to the leveling jacks, hitch tongue or tires, or may be held in place with ballast type of weights.

An optional attribute of this embodiment 55 is the addition of a tire or wheel cover or RV slide out or extension apparatus 52, which protects the area below the slide out or extension (see FIG. 14). This optional attribute 52 may be removable, semi-permanently or permanently attached to the base mat 3. The tire cover or RV slide out or extension 52 may be constructed in a manner similar to the base mat 3 with polyelectrical rope, polyelectrical tape or polyelectrical wire 1,2 attached. Temporary or portable attachment may be by hook and loop closures, or other durable and non-electrical conducting methods.

I claim:

1. An electronic apparatus for deterring rodents, comprising:
an synthetic non-electricity conducting mat, that is durable, flexible, shape conforming, permeable to air and water, said mat defining an area and said area is surrounded by a perimeter, said perimeter further comprising an electricity insulator;
a plurality of rows of positively charged wires and a plurality of rows of negatively charged wires, said rows of positively charged wires and said rows of negatively charged wires being attached to said mat, wherein said rows of positively charged wires and said rows negatively charged wires alternate in position throughout said mat, and said rows of positively charged wires and said rows of negatively charged wires are positioned to define a space between said rows, wherein said plurality of positively charged wires and said plurality of negatively charged wires are comprised of polyelectrical rope, polyelectrical tape or polyelectrical wire, said polyelectrical rope, polyelectrical tape or polyelectrical wire being attached to the upper surface of said mat; and
a low impedance electric charge controller, said electric charge controller AC, DC or solar powered, with the positive terminal of said electric charge controller being attached to said rows of positively charged polyelectrical rope, polyelectrical tape or polyelectrical wire, and with the negative charge terminal of said electric charge controller being attached to said rows of negatively charged polyelectrical rope, polyelectrical tape or polyelectrical wire, and said electric charge controller providing a positive current to said rows of positively charged polyelectrical rope, polyelectrical tape or polyelectrical wire wires, said electric charge controller providing a negative current to said rows of negatively charged polyelectrical rope, polyelectrical tape or polyelectrical wire.

2. The apparatus of claim 1 wherein said mat is a non-electricity conducting synthetic material, said mat may be comprised of multiple layers of polyvinyl chloride, polyvinyl chloride coated nylon, polyester, polyethylene, nylon, fiberglass or vinyl material.

3. The apparatus of claim 1 wherein said polyelectrical rope, polyelectrical tape or polyelectrical wire is constructed from woven polyethylene or polyvinyl chloride coated fiberglass, and which includes strands of electrical conducting wire woven into or attached to said matrix.
